(19) United States
(12) Patent Application Publication
(10) Pub. No.: US 2015/0047927 A1
(43) Pub. Date: Feb. 19, 2015

(54) REMOVABLE LOCK FOR ATTACHING ADDITIONAL EXTENSION LADDER

(71) Applicant: Alejandro Escalona Nodarse, Marietta, GA (US)

(72) Inventor: Alejandro Escalona Nodarse, Marietta, GA (US)

(21) Appl. No.: 14/231,583

(22) Filed: Mar. 31, 2014

Related U.S. Application Data
(60) Provisional application No. 61/865,561, filed on Aug. 13, 2013.

(51) Int. Cl. E06C 7/06; E06C 1/12

(52) U.S. Cl. CPC E06C 7/06; E06C 1/12
USPC 182/209

(57) ABSTRACT

A removable locking device for attaching a base ladder to one or more flys of an extension ladder is disclosed herein. The removable locking device is slightly greater in width than the extension ladder. This allows the locking device to simultaneously grasp both the left and right sides of both the base extension ladder and the additional fly extension ladders. The side rails comprise cavities for a plurality of rungs of the extension ladder. The locking device contains insertion pins for engaging the rung cavities along the side rails of the ladders. The locking device contains a further clamping mechanism to engage the base ladder with the fly extension ladder and to secure the insertion pins within the rung cavities of both ladders. With the clamping mechanism engaged, the base extension ladder and the fly extension ladders become locked together, temporarily creating a single securely engaged ladder.

### CROSS-REFERENCE TO RELATED APPLICATION

This application claims the benefit of U.S. Provisional Application No. 61/865,561, filed Aug. 13, 2013.

### FIELD OF THE INVENTION

The present invention relates generally to locking devices for securely attaching sections of an extension ladder together and, more particularly, to a locking device for providing a safer solution for securely attaching an additional extension ladder or section of it, to an existing extension ladder to increase the existing ladder's reach.

### BACKGROUND OF THE INVENTION

In the past, construction workers and some general users discovered that sometimes extension ladders available in the market are not long enough to accomplish certain tasks. With the increasing trend of building larger houses, taller buildings, and the like, the use of forty foot extension ladders has become a common activity. Unfortunately, ladders taller than this size are frequently needed and are rarely available in the work place. To overcome this impediment a common practice among professionals is the use of ropes to attach a single section or to fasten two extension ladders together to reach the desired length. This practice is forbidden by regulating authorities, but in most cases these regulations only apply to companies and not to individual users. This unconventional practice, however, sometimes creates an uncomfortable feeling in users, who might fear that an accident might occur. Despite this, and because of circumventable regulations, people still engage in this risky practice because they know that they cannot be cited for this practice unless they have employees.

Painters and other construction professionals and tradespeople learned that on many occasions the extension ladders available in the market or in the workplace are not tall enough to perform certain tasks. Even for professionals, 36′ and 40′ extension ladders are difficult to maneuver and transport. The use of two smaller ones instead, enhances the portability, storage and cost aspects. Furthermore, smaller size ladders are unlikely to bend when they fall, and generally the combination of two of them will suffice to accomplish most of the jobs. In unconventional but ingenious ways, construction professionals have figured out that attaching two extension ladders together with ropes, or nailing boards on the roofs to secure the extension ladders, could help them to reach places at greater heights. These methods, in addition to being dangerous, often scare clients, who do not want accidents happening on their properties. However, despite the regulations to avoid misuse of ladders, and the inconvenience caused to property owners, these risky actions are performed on a daily basis. On other occasions, construction professionals sometimes decline jobs involving work in areas unreachable with conventional extension ladders, even if the amount of work in these areas will be minimal compared with the complete project, to avoid such risks. The present invention not only solves these problems, but eliminates others. For example, the embodiments of the present invention may eliminate the necessity to buy the heavy long extension ladders, which are difficult to store and transport. The present invention eliminates all these problems and creates many more advantages.

The present invention meets one or more of the above-referenced needs as described herein in greater detail.

### SUMMARY OF THE INVENTION

Embodiments disclosed herein relate to a Removable Lock For Attaching Additional Extension Ladder Sections. More particularly, the embodiments herein disclose a locking device to provide a safer solution for attaching an additional extension ladder, or a section of it, to another extension ladder to increase its reach. Briefly described, aspects of the present embodiments include the following.

A removable locking device for attaching a base ladder to one or more flys of an extension ladder is disclosed herein. The removable locking device is slightly greater in width than the extension ladder. This allows the locking device to simultaneously grasp both the left and right sides of both the base extension ladder and the additional fly extension ladders. The side rails comprise cavities for a plurality of rungs of the extension ladder. The locking device contains insertion pins for engaging the rung cavities along the side rails of the ladders. The locking device contains a further clamping mechanism to engage the base ladder with the fly extension ladder and to secure the insertion pins within the rung cavities of both ladders. With the clamping mechanism engaged, the base extension ladder and the fly extension ladders become locked together, temporarily creating a single securely engaged ladder.

In a further embodiment, the locking device uses spring-loaded insertion pins to engage the rung cavities along the side rails of the extension ladder. The locking device uses dual sets of spring-loaded insertion pins on the left and right sides of the locking device to simultaneously engage the rung cavities along the side rails of both the base extension ladder as well as the joined fly extension ladder. The locking device can further utilize brackets to align the rungs of the fly extension ladder with the base extension ladder for additional stability and engagement with the locking mechanism.

In still another embodiment, the locking device uses a clamping jaw to firmly engage the rungs while the inserting pins are inside cavities of the extension ladder rungs such that the base ladder and the fly extension ladder are firmly locked together. Alternatively, the locking device can use a threaded screw clamp to engage the rungs of the ladder such that the base ladder and the fly extension ladder are firmly locked together. In still another embodiment, the locking device uses a “U” shaped brace to simultaneously engage aligned rungs of the base ladder and the fly extension ladder along with the clamping mechanisms to temporarily create a stable and secured elongated extension ladder.

The above features as well as additional features and aspects of the present invention are disclosed herein and will become apparent from the following description of preferred embodiments of the present invention.

This summary is provided to introduce a selection of aspects and concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1a is a perspective view of a removable ladder extension lock securely attaching multiple extension ladders together according to an embodiment;

FIG. 1b is a close-up perspective view of the removable ladder extension lock securely attaching multiple extension ladders together according to an embodiment;

FIG. 2 is an internal view of the removable ladder extension lock according to an embodiment;

FIG. 3 illustrates a removable ladder extension lock incorporating “U” brackets in accordance with a second embodiment of the invention;

FIG. 4 illustrates a cross-sectional view of a removable ladder extension lock incorporating a second pair of inserting pins in accordance with a third embodiment of the invention;

FIG. 5 illustrates a cross-section view of the removable ladder extension lock illustrated in FIG. 4 in accordance with a third embodiment of the invention;

FIG. 6 illustrates a cross-sectional view of the removable ladder extension lock incorporating a locking bolt and jaw mechanism in accordance with a fourth embodiment of the invention;

FIG. 7 is a later lateral cross-sectional view of the removable ladder extension lock illustrated in FIG. 6 in accordance with a fourth embodiment of the invention; and

FIG. 8 is a cross-sectional view of the removable ladder extension lock that incorporates a latch for securely clamping the inner portion of a ladder's side rail in accordance with a fifth embodiment of the invention.

### DETAILED DESCRIPTION

Before the present methods and systems are disclosed and described in greater detail hereinafter, it is to be understood that the methods and systems are not limited to specific methods, specific components, or particular implementations. It is also to be understood that the terminology used herein is for the purpose of describing particular aspects and embodiments only and is not intended to be limiting.

As used in the specification and the appended claims, the singular forms “a,” “an,” and “the” include plural referents unless the context clearly dictates otherwise. Similarly, “optional” or “optionally” means that the subsequently described event or circumstance may or may not occur, and the description includes instances where the event or circumstance occurs and instances where it does not.

Throughout the description and claims of this specification, the word “comprise” and variations of the word, such as “comprising” and “comprises,” mean “including but not limited to,” and is not intended to exclude, for example, other components, integers or steps. “Exemplary” means “an example of” and is not intended to convey an indication of preferred or ideal embodiment. “Such as” is not used in a restrictive sense, but for explanatory purposes.

Disclosed herein are components that can be used to perform the disclosed methods and systems. It is understood that when combinations, subsets, interactions, groups, etc. of these components are disclosed that although specific reference to each various individual and collective combinations and permutations cannot be explicitly disclosed, each is specifically contemplated and incorporated herein, for all methods and systems. This applies to all aspects of this specification including, but not limited to, steps in disclosed methods. Thus, if there are a variety of additional steps that can be performed it is understood that each of the additional steps can be performed with any specific embodiment or combination of embodiments of the disclosed methods.

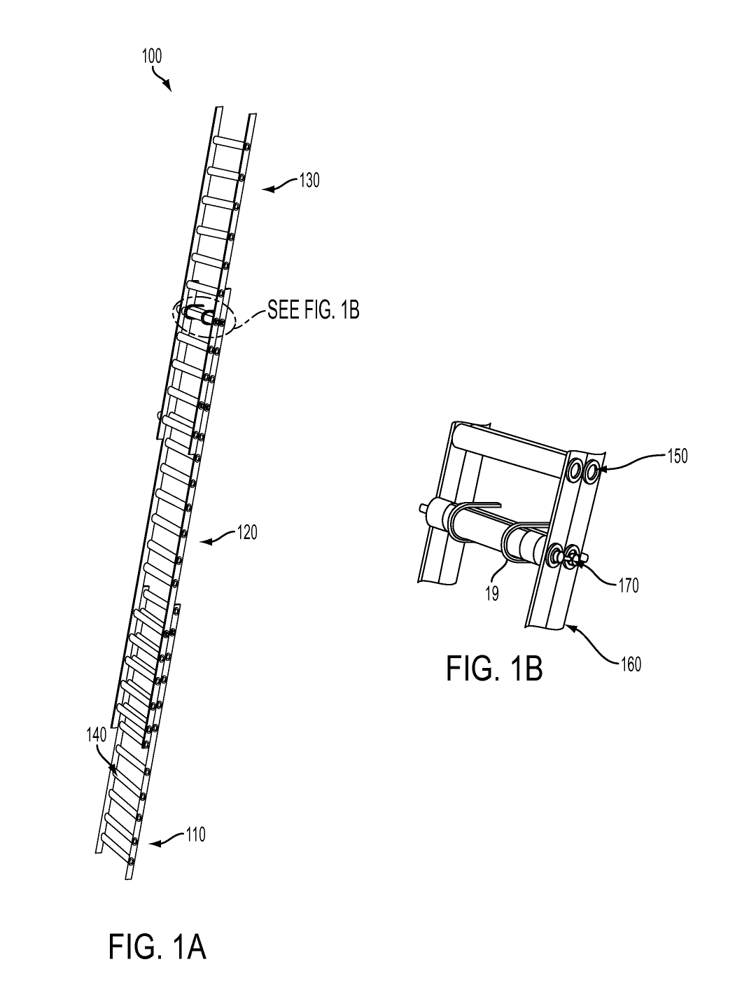

Turning now to FIG. 1, an exemplary embodiment 100 of the present invention is illustrated. FIG. 1 illustrates a base extension ladder 110 having a plurality of rungs 140 placed between the ladder's side rails 160 for reaching the height of the ladder. Connected to the base extension ladder 110 are a plurality of extension ladder flys 120 and 130 that allow the height of the base extension ladder to be extended. Each rung 140 of the base extension ladder 110 and the extension ladder flys 120 and 130 has a hollow rung cavity 150 opening which helps to reduce the weight of the ladders. In the exemplary embodiment, the removable locking device 170 takes advantage of these rung cavities 150 by inserting locking pins within these cavities, which allow two or more extension ladders to be joined together as explained below.

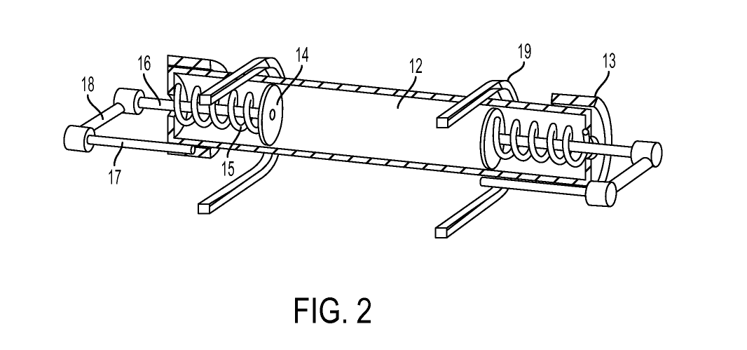

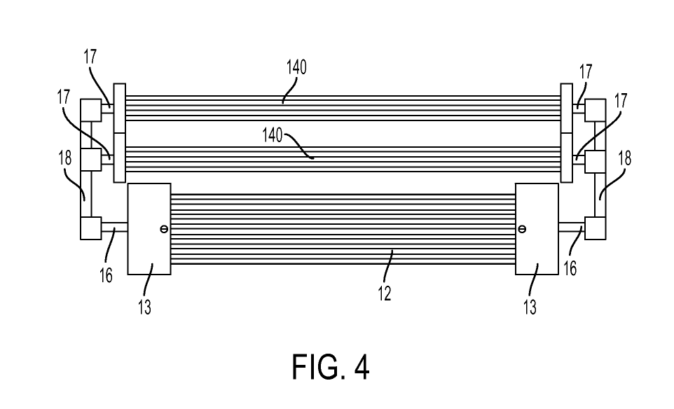

The removable locking device 170 is illustrated in greater detail in FIG. 2. The removable locking device 170 features a number of components that connect to a connection rod 12 that forms the foundation of the device. The connection rod 12 is slightly greater in width than the base extension ladder 110 and the extension ladder flys 120-130. In an exemplary embodiment, this connection rod 12 has a shape that is substantially similar to the rungs 140 of the extension ladders 110-130. When the removable locking device is attached, the connection rod 12 rests against and effectively creates an extension to one of the rungs on the ladders 110-130. On both the left and right sides of the connection rod 12 are end caps 13 that protect the interior mechanism of the removable locking device 170. The interior mechanism includes a flange 14 for compressing a spring 15 between the flange 14 and the end caps 13 of the removable locking device 170. The flange 14 is further connected to a shaft 16 that connects to an insertion pin 17 connected to a handle bar 18 for directing the movement of the insertion pin 17 in the direction of movement of the shaft 16 and spring 15. The springs 15 extend longitudinally around the pair of shafts 16 respectively. Each of the shafts 16 connects independently to the flange 14 on one end, while the other end extends outside the connecting rod 12, passing through the ends caps to abut with the handle bar 18. In an exemplary embodiment, the shaft 16 is of sufficient length to allow the insertion pin 17 to clear the sides of the extension ladders 110-130 while the handle bars 18 are pulled away from side rails 160 of the ladders 110-130, compressing the spring 15, and allowing the removable locking device 170 to be attached to two or more ladders 110-130. Although only one insertion pin is illustrated in FIG. 2, in an exemplary embodiment, there at least two insertion pins 17 connected to the handle bar 18 as shown in FIG. 4. In a further exemplary embodiment, the insertion pins 17 are placed along the handle bar 18 at such a distance that they align with the rung cavities 150 along the side rails of the extension ladders 110-130. The removable locking device 170 is aligned with rungs of the extension ladders 110-130 using brackets 19. In an exemplary embodiment, the brackets 19 are “U” shaped for embracing at least two parallel rungs 140 of the extension ladders 110-130, while the removable locking device 170 is engaged. The combination of the flange 14 and spring 15 forces one or more insertion pins 17 to move in a horizontal direction towards the interior of the rung cavities 150 of the extension ladders 110-130. Furthermore, the insertion pins 17 and brackets 19 can be coated with a non-slip material such as rubber, soft polymers, wood or cork.

Further in FIG. 2, the removable locking device's 170 insertion pins 17 are operable using a handle bar 18. The spring loaded mechanism created by the combination of the flange 14, spring 15, shaft 16 and handle bar 18 allow the removable locking devices 170 to be clamped onto the extension ladders 110-130. A user operates the device by aligning parallel rungs 140 of at least two extension ladders 110-130 together using the brackets 19 while pulling the handle bars 18 away from the extension ladders 110-130, compressing the spring 15. The user then aligns the insertion pins 17 with the rung cavities 150, and releases the handle bar 18 such that the insertion pins slide into the rung cavities 150, joining both the locking device 170 and two or more extension ladders 110-130 together.

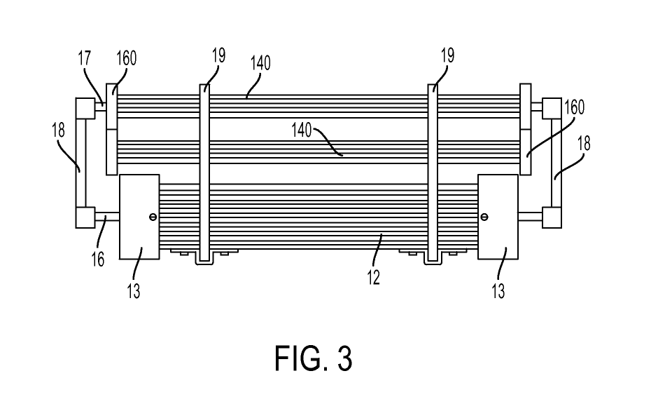

Turning now to FIG. 3, a top level view of the removable locking device 170 engaging two parallel rungs 140 of two ladders 110-130 is illustrated. As discussed above, removable locking mechanism 170 comprises a connecting rod 12, end caps 13, shaft 16, handle bar 18, insertion rods 17 and “U” shaped brackets 19. The “U” shaped brackets engage parallel rungs 140 of the ladders 110-130 while the insertion pins 17 engage rung cavities 150, disposed along the side rails 160 of the ladders 110-130, thereby locking the two ladders 110-130 together.

Further to FIG. 3, in FIG. 4, a top level view of the removable locking device 170 engaging two parallel rungs 140 of two ladders 110-130 is also illustrated. As discussed above, removable locking mechanism 170 comprises a connecting rod 12, end caps 13, shaft 16, handle bar 18, insertion rods 17 and “U” shaped brackets 19. The “U” shaped brackets engage parallel rungs 140 of the ladders 110-130 while the insertion pins 17 engage rung cavities 150, disposed along the side rails 160 of the ladders 110-130, thereby locking the two ladders 110-130 together. However, as illustrated in this embodiment, the handle bar 18 comprises multiple insertion pins 17 for engaging the rung cavities of both the attached ladders 110-130. In an exemplary embodiment, the removable locking device 170 comprises the two insertion pins 17 along its handle bars 18. However, there could be one, two, three or more insertion pins along each handle bar depending on the need or application.

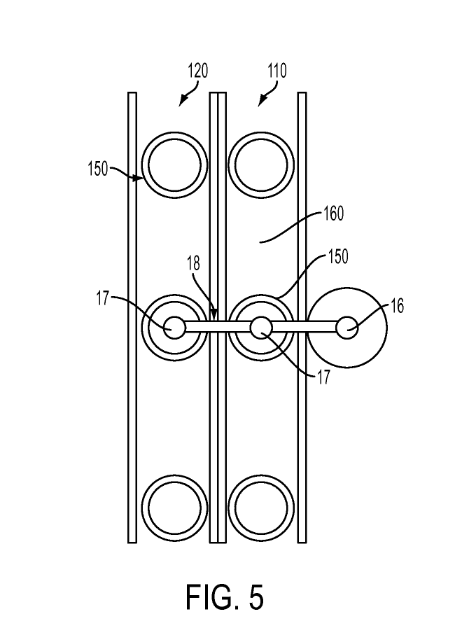

Turning now to FIG. 5, the side rails 160 of two ladders 110, 120 are illustrated. Disposed along the side rails 160 of the two ladders 110, 120 are the rung cavities 150. These cavities are hollowed out openings, similar to metal or fiberglass pipes that make up the rungs 140 of the ladders 110, 120. FIG. 5 illustrates the engagement of the insertion pins 17 into the cavities 150 and described in the discussion of FIGS. 3 and 4 above. These insertion pins 17 are connected to the handle bar 18 and shaft 16 such that they align with the rung cavities 150. These insertion pins 17 may be similar in girth to the rung cavities 150 such that there is a snug fit. In a further embodiment, the insertion pins 17 may comprise a metal rod coated with rubber, plastic, cork or other materials to ensure a snug fit with a variety of openings of the rung cavities 150.

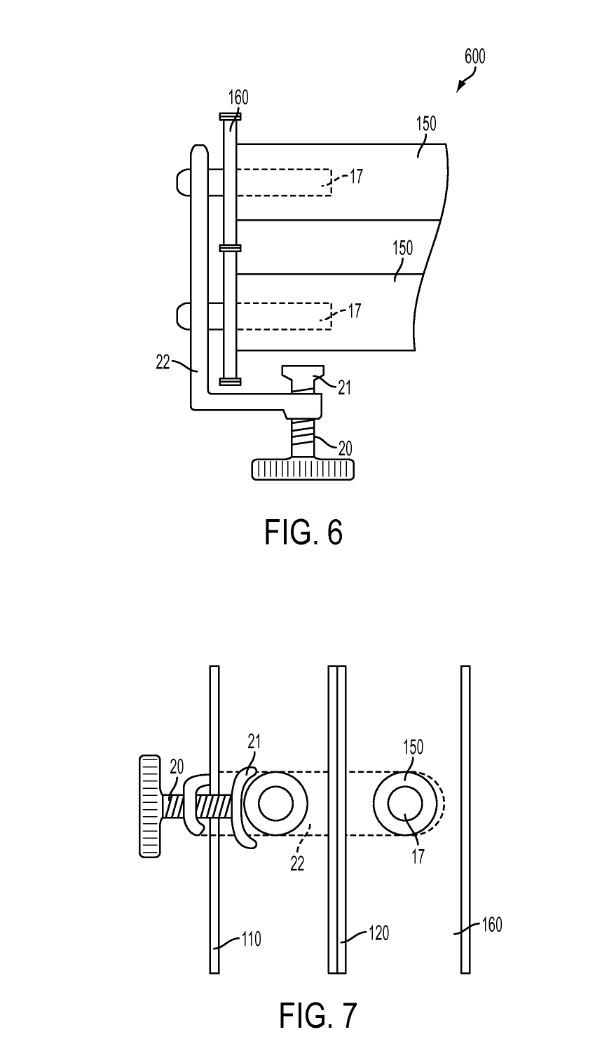

FIGS. 6 and 7 illustrate another embodiment of a removable locking device 600 wherein the insertion pins 17 are not spring loaded, but fixed to a handle bar 22. In this embodiment there are separate removable locking devices 600 for both the right and left sides of the ladders 110-130. FIG. 6 illustrates the removable locking device 600 engaging one side of the adjoined ladders, by placing the insertion pins into the rung cavities 150 and then using a screw clamp 20 to frictionally engage its jaw 21 with a corresponding rung of the ladders 110-130. FIG. 7 illustrates a further perspective view of the removable locking device 600. Illustrated in FIG. 7, the jaw 21 of the screw clamp 20 frictionally engages to a rung 140 of ladder 110, while the insertion pin 17 is inserted into the rung cavity 150 of ladder 120. This allows both ladders 110 and 120 to be locked together.

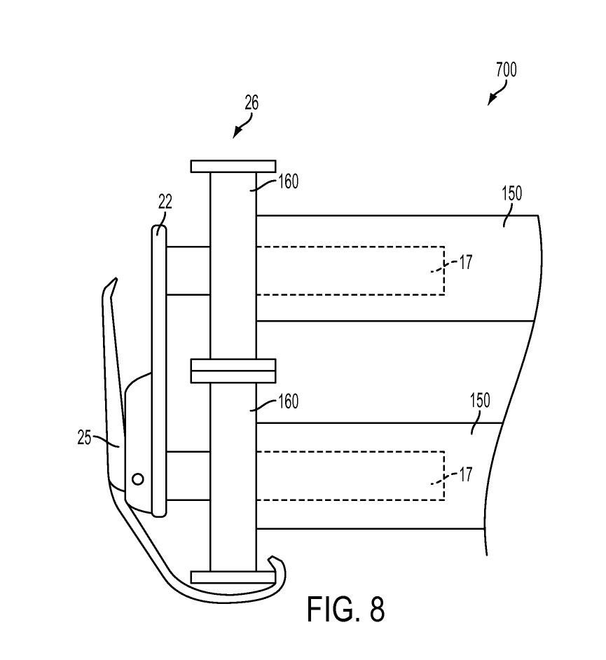

FIG. 8 illustrates still another embodiment of the removable locking device 700. Here, the insertion pins 17 are also not spring loaded, but fixed to a handle bar 22. In this embodiment there are separate removable locking devices 700 for both the right and left side of the combined ladders 110-130. The removable locking device 700 engages one side of the adjoined ladders, by placing the insertion pins 17 into the rung cavities 150 and then using a spring latch 25 to frictionally clamp its jaw to the side caps 26 of the ladders 110-130. A second removable locking device 700 engages the other side of the adjoined ladders, by placing the insertion pins into the rung cavities 150 and then using a spring latch 25 to frictionally clamp its jaw to the side caps 26 of the ladders 110-130.

Although the discussion has generally focused on just one removable locking device 170, 600, 700 being used in each application, in an embodiment multiple locking devices may be used to engage two or more ladders 110-130 along a multiple points to ensure the stability of the adjoined ladders.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A removable locking device for attaching additional extension ladder sections together, the device comprising:
a locking device with a central connecting rod, wherein the connecting rod has supports locking mechanisms on either end for simultaneously grasping both the left and right sides of a base extension ladder and the left and right sides of one or more additional fly extension ladders;
the locking device engages the rungs of both the base extension ladder and the fly extension ladder using parallel brackets that extend perpendicularly from the central connecting rod to embrace the rungs,
the locking mechanisms also engages the rung cavities along the side rails of the additional fly extension ladder using insertion pins on both the left and right sides, such that the base extension ladder and one or more fly extension ladders become integrally locked together, temporarily creating a single securely engaged ladder.

2. The locking device according to claim 1, wherein the locking device uses spring-loaded insertion pins on the left and right sides of the locking device that run parallel to the connecting rod to simultaneously engage the rung cavities along the side rails of both the base extension ladder and the fly extension ladder.

3. The locking device according to claim 1, wherein the locking device uses dual sets of spring-loaded insertion pins on the left and right sides of the locking device that run parallel to the connecting rod to simultaneously engage the rung cavities along the side rails of both the base extension ladder, joining the base extension ladder to the fly extension ladder.

4. The locking device according to claim 1, wherein the locking device utilizes parallel brackets that rests upon the rungs of both the base extension ladder and the fly extension ladder- to align the rungs of the fly extension ladder with the base extension ladder for stability and engagement with the locking mechanism.

5. The locking device according to claim 4, wherein the locking device further uses “U” shaped brackets that extend perpendicularly from the central connecting rod to simultaneously engage aligned rungs of the base ladder and the fly extension ladder to create a stable and secured elongated extension ladder.

6. The locking device according to claim 1, wherein the connection rod is coated with a non-slip material such as rubber, soft polymers, wood or cork.

7. The locking device according to claim 1, wherein the locking device comprises dual insertion pins on both the left and right sides that run parallel to the connecting rod, such that both the rung cavities on the based extension ladder and the fly extension ladder can be simultaneously engaged.

8. The locking device according to claim 7, wherein the insertion pins are coated with a non-slip material such as rubber, soft polymers, wood or cork.

9. A locking device for attaching one or more flys to a base extension ladder comprising:
a locking device having both left and right sides with a central connecting rod, wherein the connecting rod has supports locking mechanisms on both the left and right sides, such that the locking device can simultaneously grasp both the left and right sides of the base extension ladder and the left and right sides of one or more addition fly extension ladders;
the locking device having spring loaded insertion pins that run parallel to the connecting rod for engaging rung cavities along the side rails of both the base extension ladder and the additional fly extension ladder, wherein the insertion pins of the locking device engage the rung cavities along the side rails of the extension ladders such that the base extension ladder and one or more fly extension ladders become locked together, temporarily creating a single securely engaged ladder.

10. The locking device according to claim 9, wherein each side of the locking device comprises the spring-loaded insertion pins that run parallel to the connecting rod for engaging the rung cavities along the side rails of each side of the extension ladder.

11. The locking device according to claim 10, wherein the insertion pins are coated with a non-slip material such as rubber, soft polymers, wood or cork.

12. The locking device according to claim 9, wherein the locking device uses dual sets of spring-loaded insertion pins on the left and right sides of the locking device that run parallel to the connecting rod to simultaneously engage the rung cavities along the side rails of both the base extension ladder as well as the joined fly extension ladder.

13. The locking device according to claim 9, wherein the locking device utilizes parallel brackets that rests upon the rungs of both the base extension ladder and the fly extension ladder to align the rungs of the fly extension ladder with the base extension ladder for stability and engagement with the locking mechanism.

14. The locking device according to claim 13, wherein the locking device further uses “U” shaped brackets that extend perpendicularly from the central connecting rod to simultaneously engage aligned rungs of the base ladder and the fly extension ladder to create a stable and secured elongated extension ladder.

15. The locking device according to claim 1, wherein the rungs of the ladder are coated with a non-slip material such as rubber, soft polymers, wood or cork.

16. The locking device according to claim 14, wherein the insertion pin are of sufficient girth to maximize frictional engagement with the rung cavities.

17. A removable locking device for increasing the length of an extension ladder comprising:
a locking mechanism for engaging a side of both base extension ladder and a fly extension ladder;
a locking mechanism comprising insertion pins for engaging a rung cavity in the side rails of both the base extension ladder and the fly extension ladder; and
the locking mechanism frictionally engages the base extension ladder to the fly extension ladder such that both ladders are securely attached together.

18. The removable locking device according to claim 17, wherein the locking mechanism uses a clamping jaw to firmly engage the rungs of the ladders while the insertion pins are inside the rung cavities such that the base ladder and the fly extension ladder are firmly locked together.

19. The removable locking device according to claim 17, wherein the locking mechanism uses a threaded screw clamp to engage the rungs of the ladders while the insertion pins are inside the rung cavities such that the base ladder and the fly extension ladder are firmly locked together.

20. The locking device according to claim 17, wherein the dual locking devices may be simultaneously aligned and attached in parallel to the side rails of the base ladder and the fly extension ladder in order to secure attach two or more ladders together.
